(19) United States
(12) Patent Application Publication
(10) Pub. No.: US 2009/0073392 A1
(43) Pub. Date: Mar. 19, 2009

(54) Illumination System Including Grazing Incidence Mirror For Microlithography Exposure System

(75) Inventors: Hans-Juergen Mann, Oberkochen (DE); Wilhelm Ulrich, Aalen (DE); Daniel Kraemer, Essingen (DE); Toralf Gruner, Aalen-Hofen (DE); Aurelian Dodoc, Oberkochen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/855,359

(22) Filed: Sep. 14, 2007

(51) Int. Cl. G03B 21/28; G03B 21/06

(52) U.S. Cl. 353/66; 353/65

(57) ABSTRACT

In general, in one aspect, the invention features a system that includes a catoptric projection objective having an optical axis and including a plurality of projection objective elements positioned between an object plane and an image plane, the object and image planes being orthogonal to the optical axis, the projection objective being configured so that during operation the projection objective directs radiation reflected at the object plane to the image plane to form an image at the image plane of an object positioned in a field at the object plane, the field having a first dimension of 8 mm or more and a second dimension of 8 mm or more, the first and second dimensions being along orthogonal directions. The system also includes an illumination system including a plurality of illumination system elements, the illumination system being configured so that during operation the illumination system directs the radiation to the field at the object plane, where a chief ray of the radiation has an angle of incidence of 10° or less at the object plane.

### TECHNICAL FIELD

This disclosure relates to illumination systems and to microlithography exposure system that use illumination systems.

### BACKGROUND

Illumination systems are widely used in microlithography to illuminate a reticle with radiation having a desired homogeneity and pupil fill. A projection objective is then used to transfer a pattern from the reticle to a substrate by forming an image of the reticle on a layer of a photosensitive material disposed on the substrate. In general, illumination systems fall into three different classes: dioptric systems; catoptric systems; and catadioptric systems. Dioptric systems use exclusively refractive elements (e.g., lens elements) to shape radiation from a source to have desired properties at an object plane of the projection objective. Catoptric systems use exclusively reflective elements (e.g., mirror elements) to shape the radiation. Catadioptric systems use both refractive and reflective elements to shape the radiation.

### SUMMARY

Microlithography exposure systems are disclosed that feature illumination systems for illuminating reflective reticles. In order to illuminate the reticle, at least the last element in the radiation path of the illumination system is positioned on the same side of the reticle as the projection objective. Accordingly, the optical design of such systems should account for the relative positioning of the last element of the illumination system relative to the elements of the projection objective. In certain embodiments, the last element of the illumination system is a grazing incidence mirror, configured relative to the projection objective to illuminate a relatively large field at the object plane with relatively low incidence angles.

In general, in a first aspect, the invention features a system that includes a catoptric projection objective having an optical axis and including a plurality of projection objective elements positioned between an object plane and an image plane, the object and image planes being orthogonal to the optical axis, the projection objective being configured so that during operation the projection objective directs radiation reflected at the object plane to the image plane to form an image at the image plane of an object positioned in a field at the object plane, the field having a first dimension of 8 mm or more and a second dimension of 8 mm or more, the first and second dimensions being in orthogonal directions. The system also includes an illumination system including a plurality of illumination system elements, the illumination system being configured so that during operation the illumination system directs the radiation to the field at the object plane, where a chief ray of the radiation has an angle of incidence of 10° or less (e.g., about 9° or less, about 8° or less, about 7° or less, about 6°) at the object plane.

Embodiments of the system can include one or more of the following features. For example, the chief ray can be the chief ray that intersects the object plane at a central field point.

In embodiments, the projection objective includes a first projection objective element and the illumination system includes a first illumination system element, the first projection objective element being the first element in a path of the radiation from the object plane to the image plane and the first illumination system element being the last element in the illumination system in the path of the radiation prior to the object plane, where the first projection objective element can be closer to the object plane than the first illumination system element. The first illumination system element can be positioned a distance zₘᵢₙ or more from the object plane, where zₘᵢₙ is given by the equation:

$${z}_{min} = \frac{dy + {y}_{min}}{Γ} ,$$

in which

$$Γ = tan [ arcsin [ sin ( arctan ( \frac{( {y}_{0} - dy / 2 ) \cdot tan ( CRAO )}{{y}_{0}} ) ) - σ \cdot NAO ) ] ] + tan [ arcsin [ sin ( arctan ( \frac{( {y}_{0} + du / 2 ) \cdot tan ( CRAO )}{{y}_{0}} ) ) - NAO ) ] ] ,$$

where NAO is the numerical aperture of the projection objective at the object plane, σ is the relative numerical aperture of the illumination system at the object plane, CRAO is the chief ray angle of a central field point at the object plane, dy is the dimension of the field in the direction orthogonal to the optical axis, y₀ is a distance between the central field point and the optical axis, and yₘᵢₙ is a minimum separation between the radiation and either the first illumination system element or the first projection system element. The first illumination system element can be positioned further from the optical axis than the field at the object plane.

The field at the object plane can be rectangular-shaped or can be arc-shaped.

The first illumination system element can be a mirror. The mirror can be a plane mirror or a curved mirror (e.g. a torodial mirror). The mirror can be arranged as a grazing incidence mirror.

In some embodiments, the illumination system includes a field mirror including a plurality of facet mirrors and during operation the illumination system images each facet mirror to the object plane. The facet mirrors can be rectangular mirrors or arc-shaped mirrors

The first dimension can be 9 mm or more (e.g., about 10 mm or more, about 12 mm or more, about 15 mm or more, about 20 mm or more, about 30 mm or more, about 40 mm or more, about 50 mm or more). The second dimension can be 9 mm or more (e.g., about 10 mm or more, about 12 mm or more, about 15 mm or more, about 20 mm or more, about 30 mm or more, about 40 mm or more, about 50 mm or more). In some embodiments, the first dimension is about 20 mm or less (e.g., about 15 mm or less, about 12 mm or less, about 10 mm or less). In certain embodiments, the second dimension is about 40 mm or less (e.g., about 30 mm or less, about 26 mm or less, about 20 mm or less, about 15 mm or less, about 12 mm or less, about 10 mm or less). The chief ray at a central field point can have an angle of incidence of 10° or less (e.g., about 9° or less, about 8° or less, about 7° or less, about 6°). The projection objective can have an image-side numerical aperture of 0.25 or more (e.g., 0.3 or more, 0.35 or more, 0.4 or more, 0.45 or more, 0.5 or more). In some embodiments, the projection objective has an object side numerical aperture of about 0.06 or more.

The projection objective can be a reduction projection objective. In certain embodiments, the projection objective is a transfer projection objective. The projection objective can include an even number (e.g., 2, 4, 6, 8, or more) of curved (e.g., convex or concave) mirrors.

The object can be a reticle. The object can be configured to reflect radiation from the illumination system.

The system can include a source configured to produce radiation that is directed by the illumination system to the object plane. The radiation can have a wavelength that is less than 400 nm (e.g., about 248 nm or less, about 193 nm or less, about 13 nm or less).

The system can be a microlithography exposure system (e.g., a scanning microlithography exposure system).

In general, in another aspect, the invention features a system that includes a catoptric projection objective having an optical axis and including a plurality of projection objective elements including a first projection objective element, the projection objective being configured so that during operation the projection objective directs radiation from an object plane to an image plane to form an image at the image plane of an object positioned in a field at the object plane, the first projection objective element being the first element in a path of the radiation from the object plane to the image plane and the field having a dimension of 8 mm or more in a direction orthogonal to the optical axis. The system also includes an illumination system having a plurality of illumination system elements including a first illumination system element, the illumination system being configured so that during operation the illumination system directs the radiation to the field at the object plane, where the first illumination system element is the last illumination system element in the path of the radiation prior to the object plane. A chief ray of the radiation has an angle of incidence of 10° or less at the object plane, and the first illumination system element is on the same side of the object plane as the first projection objective element. Embodiments of the system can include one or more of the features listed above with respect to the first aspect.

In general, in another aspect, the invention features a system that includes a projection objective including a plurality of projection objective elements including a first projection objective element, the projection objective being configured so that during operation the projection objective directs radiation from an object plane to an image plane to form an image at the image plane of an object positioned at the object plane, the first projection objective element being the first element in a path of the radiation from the object plane to the image plane. The system also includes an illumination system having a plurality of elements including a grazing incidence mirror, the illumination system being configured so that during operation the illumination system directs radiation to the field at the object plane, the grazing incidence mirror being the last element in the illumination system in the path of the radiation prior to the object plane. The first projection objective element is closer to the object plane than the grazing incidence mirror. Embodiments of the system can include one or more of the features listed above with respect to the first aspect.

In general, in a further aspect, the invention features a system that includes a catoptric projection objective having an optical axis and including a plurality of projection objective elements positioned between an object plane and an image plane, the object and image planes being orthogonal to the optical axis and the projection objective being configured so that during operation the projection objective directs radiation reflected at the object plane to the image plane to form an image at the image plane of an object positioned in a field at the object plane, the field having a dimension of 8 mm or more in a direction orthogonal to the optical axis. The system also includes an illumination system including a plurality of illumination system elements, the illumination system being configured so that during operation the illumination system directs the radiation to the field at the object plane. A chief ray of the radiation has an angle of incidence of 10° or less at the object plane. The system is a scanning microlithography exposure system and the direction orthogonal to the optical axis is a scan direction of the scanning microlithography exposure system. Embodiments of the system can include one or more of the features listed above with respect to the first aspect.

The details of one or more embodiments are set forth in the accompanying drawings and the description below. Other features and advantages will be apparent from the description, drawings, and claims.

### DESCRIPTION OF DRAWINGS

FIG. 1 is a schematic diagram of a microlithography exposure system.

FIG. 2A is a schematic diagram of an illumination system of a microlithography exposure system.

FIGS. 2B-D are schematic diagrams showing aspects of an illumination system.

FIG. 2E are plots of different intensity profiles through sections of an illuminated object field.

FIG. 3A shows an embodiment of a microlithography exposure system.

FIG. 3B is a schematic diagram showing components of the microlithography exposure system shown in FIG. 3A.

FIG. 4 is a schematic diagram showing components of a microlithography exposure system.

FIG. 5 is a diagram of an embodiment of a projection objective configured to image a reticle from an object plane to an image plane and a grazing incidence mirror for directing radiation to the reticle.

Like reference symbols in the various drawings indicate like elements.

### DETAILED DESCRIPTION

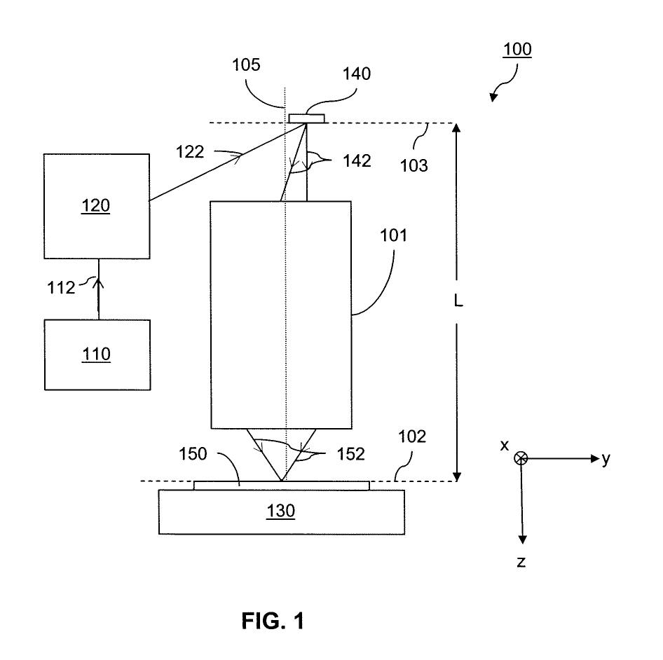

Referring to FIG. 1, a microlithography exposure system 100 generally includes a light source 110, an illumination system 120, a projection objective 101, and a stage 130. A Cartesian coordinate system is shown for reference. Light source 110 produces radiation 112 at a wavelength λ which is collected by illumination system 120. Illumination system 120 interacts with (e.g., expands and homogenizes) the radiation and directs radiation 122 to a reticle 140 positioned at an object plane 103. Projection objective 101 directs radiation 142 reflected from reticle 140 onto a light sensitive layer (e.g., a resist) on a substrate 150 positioned at an image plane 102 of projection objective 101, forming an image of reticle 140 at image plane 102. Generally, microlithography exposure system 100 is configured to image a certain portion of reticle 140 positioned at a certain region of object plane 103 to image plane 102. This region of object plane 103 is referred to as the object field and the corresponding portion at image plane 102 is referred to as the image field. The radiation on the image-side of projection objective 101 is depicted as rays 152. As shown in FIG. 1, the rays are illustrative only and not intended to be accurately depict the path of the radiation with respect to reticle 140, for example. Substrate 150 is supported by stage 130, which moves substrate 150 relative to projection objective 101 so that projection objective 101 images reticle 140 to different portions of substrate 150. In embodiments where lithography tool 100 is a scanner, the tool includes a reticle stage that moves reticle 140 in a scan direction with respect to illumination system 120.

Projection objective 101 includes a reference axis 105 (e.g., an optical axis). In certain embodiments, such as where projection objective 101 is symmetric with respect to a meridional section, reference axis 105 is perpendicular to object plane 103 and passes through the center of the object field. In certain embodiments, axis 105 intersects both the object field and the image field of projection objective 101. In some embodiments, both the object field and the image field of projection objective 101 are not intersected by axis 105. Such fields are referred to as off-axis fields.

In general, projection objective 101 can be designed to provide a desired magnification of the reticle image. In some embodiments, projection objective 101 is a reduction objective. In other words, the image at image plane 102 is smaller than the object being imaged (e.g., reduced 4× or more, 5× or more, 6× or more, 8× or more). In certain embodiments, projection objective 101 is a transfer objective or relay lens, where the object and image are the same size. In some embodiments, the image is larger than the object.

Projection objective 101 can be designed to have a desired numerical aperture (NA) at image plane 102. This is referred to as the image-side numerical aperture. In some embodiments, the image-side numerical aperture is about 0.1 or more (e.g., 0.2 or more, 0.3 or more, 0.4 or more). In certain embodiments, projection objective 101 is designed to have a very high image-side numerical aperture. For example, in some embodiments, the image side numerical aperture is in a range from 0.5 to 1 (e.g., about 0.5 or more, about 0.6 or more, about 0.7 or more, about 0.8 or more, about 0.9 or more). In some embodiments, the image-side NA can be greater than 1. For example, where an immersion liquid (e.g., as a liquid lens or planar film of liquid) is used between the final element in projection objective 101 and the substrate at the image plane, the image-side numerical aperture can be more than 1 (e.g., about 1.1 or more, about 1.2 or more, about 1.3 or more).

Projection objective 101 also has a NA at object plane 103, referred to as the object-side NA. In general, the object-side NA is related to the image-side NA by the magnification of projection objective 101. Where projection objective 101 is a transfer objective or relay lens, the object and image-side NA's are the same. Where projection objective 101 is a reduction objective, the object-side NA is smaller than the image-side NA. In some embodiments, projection objective 101 can have an object-side NA of 0.0625 or more (e.g., about 0.08 or more, about 0.09 or more, about 0.1 or more, about 0.15 or more, about 0.2 or more).

Illumination system 120 has a relative numerical aperture at object plane 103. [The relative numerical aperture, s, refers to is the quotient between the numerical aperture of the illumination system (NAI) and the numerical aperture of the projection objective (NAO): σ=NAI/NAO. Both NAI and NAO are quantities measured in the object plane of the projection objective. In other words, NAO is the same as the object-side NA discussed above. In general, the value for σ is zero for perfectly coherent illumination (i.e., plane wave illumination propagating along a single direction) and greater than 2 for incoherent illumination. Values between zero and 2 typically describe partial coherent illumination which is typical for microlithography exposure system. In certain embodiments, 0.2<σ<1 holds.

Light source 110 is selected to provide radiation at a desired operational wavelength, λ, of tool 100. In some embodiments, light source 110 is a laser light source, such as a KrF laser (e.g., having a wavelength of about 248 nm) or an ArF laser (e.g., having a wavelength of about 193 nm). Non-laser light sources that can be used include light-emitting diodes (LEDs), such as LEDs that emit radiation in the blue or UV portions of the electromagnetic spectrum, e.g., about 365 nm, about 280 nm or about 227 nm.

Typically, for projection objectives designed for operation in lithography tools, wavelength λ is in the ultraviolet portion of the electromagnetic spectrum. For example, λ can be about 400 nm or less (e.g., about 300 nm or less, about 200 nm or less, about 100 nm or less, about 50 nm or less, about 30 nm or less). λ can be more than about 2 nm (e.g., about 5 nm or more, about 10 nm or more). In embodiments, λ can be about 193 nm, about 157 nm, about 13 nm, or about 11 nm. Wavelengths in the 1 nm to 100 nm range (e.g., 13 nm) are referred to as Extreme UV (“EUV”) wavelengths. Using a relatively short wavelength may be desirable because, in general, the resolution of a projection objective is approximately proportional to the wavelength. Therefore, shorter wavelengths can allow a projection objective to resolve smaller features in an image than equivalent projection objectives that use longer wavelengths. In certain embodiments, however, λ can be in non-UV portions of the electromagnetic spectrum (e.g., the visible portion).

Typical light sources for wavelengths between 100 nm and 200 nm are excimer lasers, for example an ArF-Laser for 193 nm, an F₂-Laser for 157 nm, an Ar₂-Laser for 126 nm and a NeF-Laser for 109 nm. Since the transmission of the optical materials deteriorates with decreasing wavelength, the illumination systems can be designed with a combination of refractive and reflective components (i.e., catadioptric). For wavelengths in the EUV wavelength region, such as between 10 nm and 20 nm, lithography exposure apparatus 100 is designed as all-reflective (i.e., catoptric). Examples of EUV light sources are a Laser-Produced-Plasma-source, a Pinch-Plasma-Source, a Wiggler-Source or an Undulator-Source.

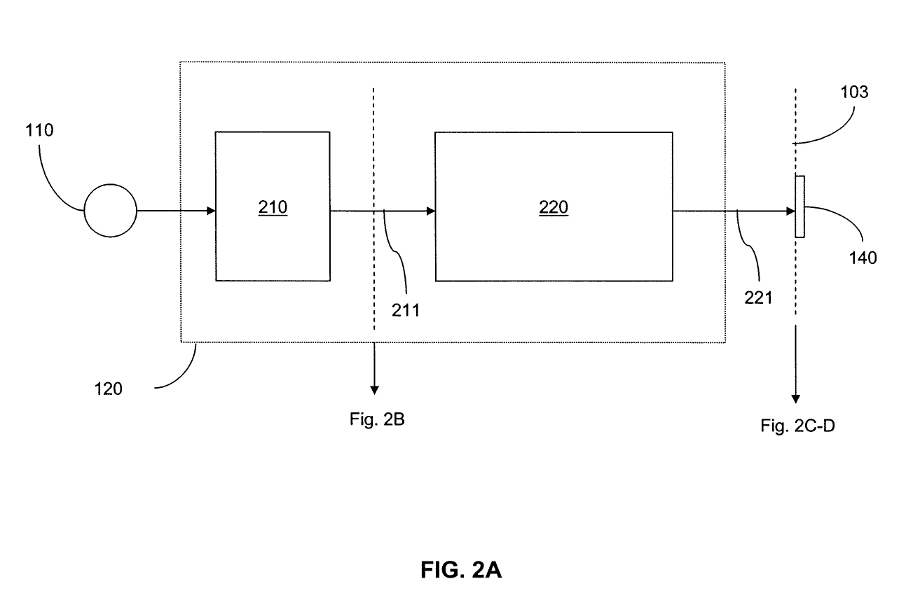

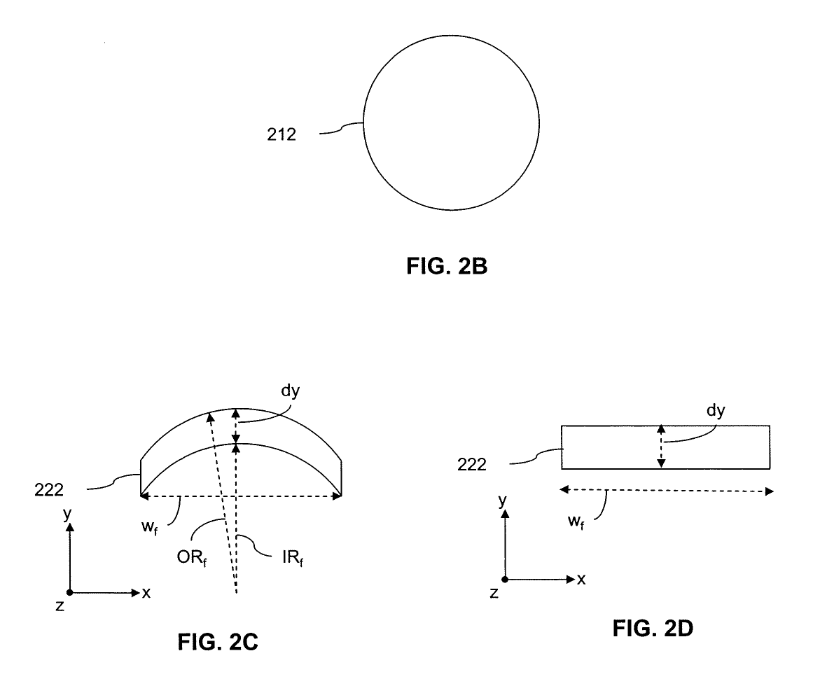

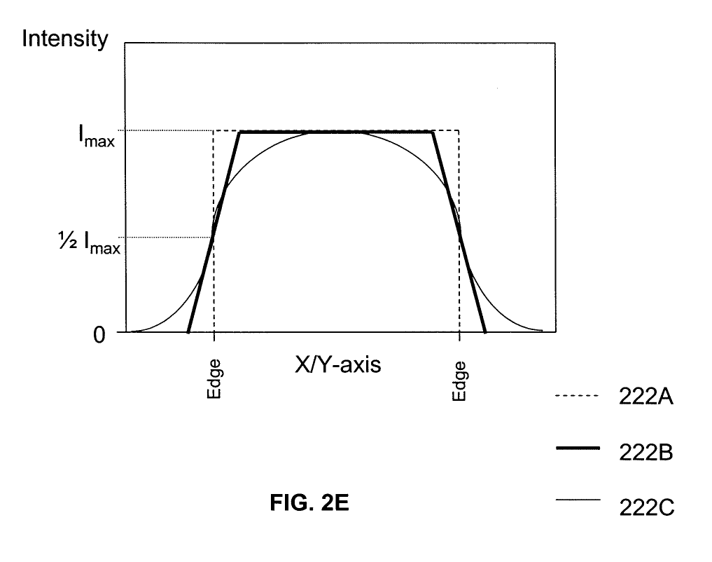

Referring to FIG. 2A, illumination system 120 includes optical components arranged to form a radiation beam with a homogeneous intensity profile and desired pupil fill. Typically, illumination system 120 includes a collector 210, configured to collect radiation from source 110 and direct the radiation as a beam along an optical path to beam shaping optics 220. Typically, collector 210 will produce a collimated or convergent beam.

In general, the shape and intensity profile of the radiation exiting collector 210 different from a desired shape and intensity profile of the radiation at object plane 103. For example, with reference to FIG. 2B, a beam profile 212 between collection optics and beam shaping optics 220 is typically substantially circular in shape with an intensity profile that can vary substantially across its width.

As discussed previously, the object field is the portion of object plane for which reticle 140 is imaged to image plane 102. In general, the shape of the object field at object plane 103 is determined by projection objective 101. Usually, the object field corresponds to a region of object plane 103 for which a reticle is imaged to image plane 102 with relatively low aberrations. Typically, the shape of the object field is dependent on the type of projection objective 101. In stepper-type lithography tools, the object field is generally rectangular in shape. In scanner-type lithography tools, the object field is typically rectangular or arc-shaped. Catoptric projection objectives, for example, typically have an arc-shaped object field.

Accordingly, beam shaping optics 220 include one or more components configured to provide a beam of radiation at objection plane 103 having a desired intensity profile across the object field and a desired pupil fill. For example, in some embodiments, beam shaping optics 220 can provide a beam having a substantially homogeneous intensity profile across the object field (e.g., the radiation intensity inside the object field varies by about ±5% or less) having the same size and shape as the object field. Other profiles are also possible as discussed below.

Referring to FIG. 2E, in general, the intensity profile of illumination across the object field can vary. Generally, it is desirable that the intensity is substantially constant in the object field, and substantially zero on either side of the field. This profile corresponds to the curve shown as 222A. In some embodiments, the radiation intensity inside the object field varies by about ±10% or less (e.g., ±8% or less, ±5% or less).

Other intensity distributions inside the object field are also possible. For example, the intensity distribution can be approximately trapezoidal (curve 222B) or approximately Gaussian (curve 222C). In the case of a scanning system, such a variation in radiation intensity typically can occur in the scan direction.

In general, the edge of the field is determined as the location where the illumination intensity is half of Iₘₐₓ, where Iₘₐₓ is the maximum illumination intensity within the field.

Referring to FIG. 2C, in catoptric systems, such as in microlithography exposure system designed for use at EUV wavelengths, an arc-shaped object field 222 is typically desired. Arc-shaped object field 222 corresponds to a segment of an annulus which is characterized by an inner radius of curvature, IR_{f}, an outer radius of curvature, OR_{f}, and a width, w_{f}. Arc-shaped field 222 is also characterized by a height at the meriodonal plane of the projection objective, d_{y}, which in this case is the difference between OR_{f} and IR_{f}. For arc-shaped object field 222, IR_{f} and OR_{f} are substantially constant across the width of the field. A Cartesian coordinate system is provided for reference in object plane 103. Width w_{f} is measured along the x-axis, while height d_{y} is measured along the y-axis (where the y-z plane is the meridional plane of projection objective 100). In general, IR_{f} can vary as desired. In some embodiments, IR_{f} is about 40 mm or more (e.g., about 50 mm or more, about 60 mm or more, about 80 mm or more, about 100 mm or more, about 150 mm or more). In certain embodiments, IR_{f} is about 500 mm or less (e.g., about 400 mm or less, about 300 mm or less, about 250 mm or less, about 200 mm or less, about 150 mm or less, about 100 mm or less). IR_{f} can be in a range from about 50 mm to about 250 mm (e.g., in a range from about 100 mm to about 200 mm).

Referring to FIG. 2D, in some embodiments, object field 222 of microlithography exposure system 100 is rectangular in shape. As for the arc-shaped field, the rectangular field is characterized by width w_{f} and height d_{y}.

In general, for arc-shaped and/or rectangular field shapes, w_{f} may vary as desired. In certain embodiments, w_{f} can correspond to a reticle die width (or multiples of reticle die widths). For example, w_{f} can be selected so that the field corresponds to one, two, three or more die widths on the wafer. In some embodiments, w_{f} is about 20 mm or more (e.g., about 30 mm or more, about 40 mm or more, about 50 mm or more, about 60 mm or more, about 80 mm or more, about 100 mm or more, about 120 mm or more). In certain embodiments, w_{f} can be in a range from about 50 mm to about 250 mm (e.g., in a range from about 80 mm to about 200 mm).

Height d_{y} can vary. In certain embodiments, it can be desirable to have a relatively large field height. For example, generally, a larger field height can be used to expose a larger image field on a substrate, reducing exposure time for a substrate and increasing throughput for the microlithography exposure system relative to apparatus with smaller field heights. In scanning system, for example, a larger field height can allow for relaxed dose control, because the exposure time for each resist point is increased. In some embodiments, dy is 4 mm or more (e.g., 5 mm or more, 6 mm or more, 8 mm or more, about 10 mm or more, about 20 mm or more, about 30 mm or more, about 40 mm or more, about 50 mm or more). In certain embodiments, dy is about 100 mm or less (e.g., about 80 mm or less, about 60 mm or less, about 50 mm or less). dy can be in a range from 5 mm to about 100 mm (e.g., in a range from 6 mm to about 60 mm, from 8 mm to about 40 mm, such as from about 10 mm to about 20 mm).

As discussed above, illumination systems generally include beam shaping optics configured to provide a beam of radiation at object plane 103 having a desired intensity profile across the object field and a desired pupil fill. For example, in some embodiments, beam shaping optics 220 include a field raster plate that directs radiation from collection optics 210 to object plane 103 in a way that provides substantially homogeneous illumination of object field 222. Moreover, beam shaping optics 220 can include one or more components configured to provide a desired fill of the exit pupil of illumination system 120, which is located at the entrance pupil of the projection objective 101. For example, beam shaping optics 220 can include one or more components that provide circular, annular, dipolar, or quadrupolar illumination at the entrance pupil of projection objective 101. An appropriate pupil raster plate can be used to perform this function.

In some embodiments, the illumination system includes a grazing incidence mirror that directs radiation from the pupil raster plate to the reticle. As used herein, a grazing incidence mirror refers to a mirror for which a maximum angle of incidence for a chief ray of the projection objective is more than 45°. In some embodiments, the maximum chief ray angle of incidence is about 60° or more (e.g., about 70° or more, about 75° or more, about 80° or more). A chief ray is a path of radiation through a microlithography exposure system that intersects the object plane at a point in the object field and intersects the optical axis of the projection objective at the aperture stop of projection objective.

The grazing incidence mirror can be a curved mirror. For example, where the field raster elements are rectangular, a curved grazing incidence mirror can be used to form an arc-shaped object field distorting the images of the rectangular raster elements to form arc-shaped images. Examples of curved grazing incidence mirrors are shown in U.S. Pat. No. 7,186,983 B2, entitled “ILLUMINATION SYSTEM PARTICULARLY FOR MICROLITHOGRAPHY,” which issued on Mar. 6, 2007, the entire contents of which is incorporated herein by reference.

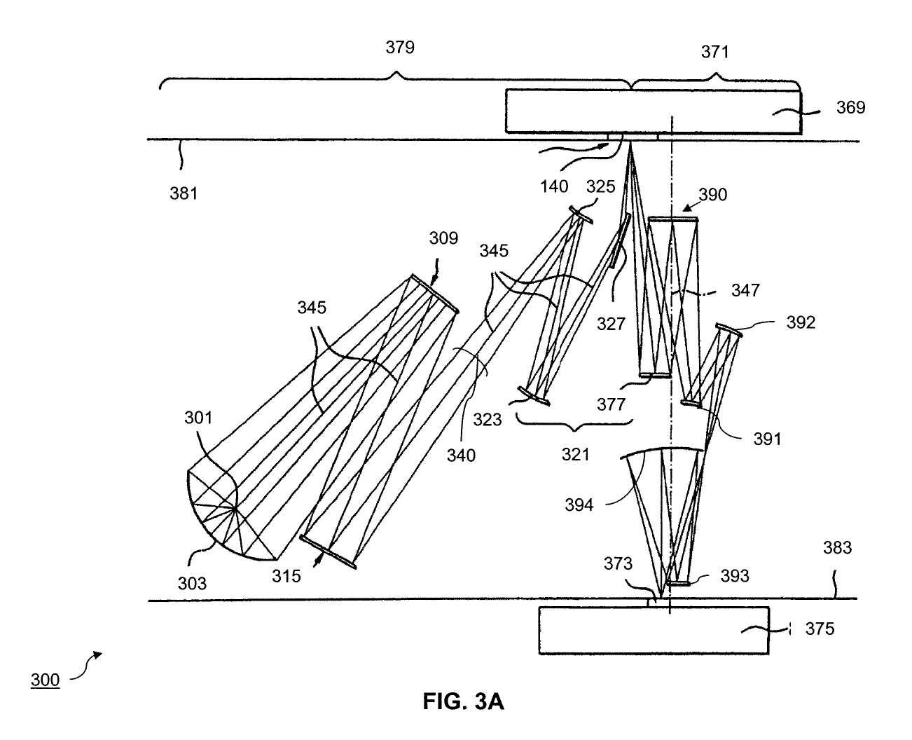

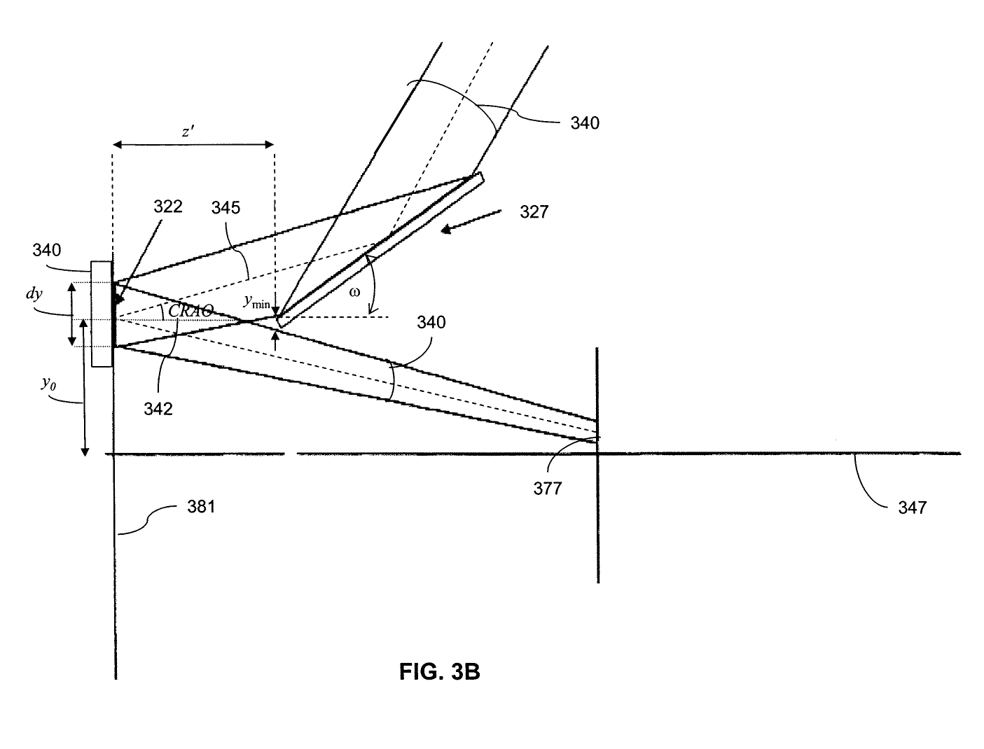

Referring to FIG. 3A, an example of such an illumination system is shown as illumination system 379, which along with projection system 371, form a microlithography projection exposure apparatus. Illumination system 379 directs radiation to a reticle 140 positioned at an object plane 381. Projection objective 371 images a portion of reticle 140 illuminated by the radiation to a wafer 373 positioned at an image plane 383. Reticle 140 is supported by a reticle stage 369 and wafer 373 is supported by a wafer stage 375.

Illumination system 379 includes a source 301, a collector 303, a field raster plate 309, a pupil raster plate 315, and mirrors 325, 323, and 327. Source 301 produces radiation that is directed by collector 303 towards field raster plate 309. The path of the radiation is illustrated by a number of rays 340, including a chief ray 345. Field raster plate 309 reflects the radiation to pupil raster plate 315. Field raster plate 309 includes a number of mirrors, each of which is imaged by illumination system 379 onto object plane 381, overlapping at an object field. Pupil raster plate 315 also includes a number of mirrors, which are arranged to provide a desired illumination shape at each point in the field at object plane 381. Mirrors 325 and 323 relay the radiation to mirror 327. Mirror 327, which is the grazing-incidence mirror, directs the radiation to object plane 381.

Projection system 371 includes a first mirror 377 and subsequent mirrors 390, 391, 392, 393, and 394 arranged along an optical axis 347. Radiation from illumination system 379 is reflected from reticle 140, and is sent toward first mirror 377 along a path illustrated by a number of rays, including ray 345. This radiation is then reflected by first mirror 377 and is subsequently directed to wafer 373 at image plane 383 via mirrors 390, 391, 392, 393, and 394, where an image of reticle 140 is formed.

Referring also to FIG. 3B, as discussed previously, mirror 327 directs rays 340 from toward reticle 140 positioned at object plane 381. Mirror 327 is arranged at an angle ω with respect to optical axis 347. Generally, ω is selected based on the direction of rays 340 prior to mirror 327 and the desired illumination angle with respect to object plane 381. ω can be in a range from about 10° to about 80° (e.g., from about 20° to about 70°, from about 30° to about 60°, from about 40° to about 50°).

Rays 340 illuminate object field 322 and the illuminated portion of reticle 140 reflects rays 340 toward first mirror 377. Object field 322 has a height, d_{y}. The central field point of object field 322 is located a distance y₀ from optical axis 347. Here, the central field point refers to the location equidistant from the edges of the object field in the meridional plane of the projection objective.

Chief ray 345 intersects object plane 381 at the central field point. Chief ray 345 has an incident angle at the central field point denoted by CRAO with respect to a normal 342 of object plane 381. In general, CRAO can vary depending upon the specific design of the microlithography exposure system. In general, the microlithography exposure system is designed so that CRAO is greater than 0° so that chief ray 345 is not reflected back towards mirror 327 when the reticle 140 is positioned at object plane 381. Typically, the microlithography exposure system is designed so that rays 340 reflected from reticle 140 are not blocked by mirror 327 prior to mirror 377. In certain embodiments, it is desirable to have a relatively low CRAO as high values of CRAO can lead to unwanted imaging effects of the projection objective. For example, high values of CRAO can lead to shadow effects at the reticle that distort the reticle information passed into the projection objective. In certain embodiments, the microlithography exposure system can be designed so that CRAO is about 10° or less (e.g., about 9° or less, about 8° or less, about 7° or less, about 6° or less, about 5° or less).

Upon reflection from reticle 140, rays 345 pass mirror 327 before incidence on mirror 377. The minimum separation between rays 345 before and after reflection from reticle 140, measured at mirror 327, is denoted by yₘᵢₙ. Generally, the microlithography exposure system is designed so that yₘᵢₙ is sufficiently large that, allowing for the physical thickness of the base of mirror 327, none of rays 340 are occluded by mirror 327. In some embodiments, yₘᵢₙ is about 2 mm or more (e.g., about 4 mm or more, about 5 mm or more, about 6 mm or more, about 8 mm or more, about 10 mm or more, about 15 mm or more, about 20 mm or more).

The minimum separation between mirror 327 and object plane 381 is denoted by z′. In general, z′ can vary. In certain embodiments, z′ is relatively small, which can allow for a design in which mirror 327 is relatively small. However, in such designs, CRAO tends to increase with increasing field height dy. Accordingly, utilizing a relatively small z′ can limit the dy where a relatively low value of CRAO is desired. Alternatively, in some embodiments, z′ can be selected so that dy is relatively large while and CRAO is relatively small. For example, z′ can be selected so that CRAO is 10° or less (e.g., 8° or less, 6° or less) while dy is more than 8 mm (e.g., about 10 mm or more, about 20 mm or more, about 30 mm or more, about 40 mm or more).

In certain embodiments, desired values of dy and CRAO can be achieved by making z′≧zₘᵢₙ, where zₘᵢₙ is given by the formula:

$${z}_{min} = \frac{dy + {y}_{min}}{Γ} ,$$

in which

$$Γ = tan [ arcsin [ sin ( arctan ( \frac{( {y}_{0} - dy / 2 ) \cdot tan ( CRAO )}{{y}_{0}} ) ) - σ \cdot NAO ) ] ] + tan [ arcsin [ sin ( arctan ( \frac{( {y}_{0} + du / 2 ) \cdot tan ( CRAO )}{{y}_{0}} ) ) - NAO ) ] ] ,$$

where NAO is object-side numerical aperture of the projection objective and σ is the relative numerical aperture of the illumination system at the object plane.

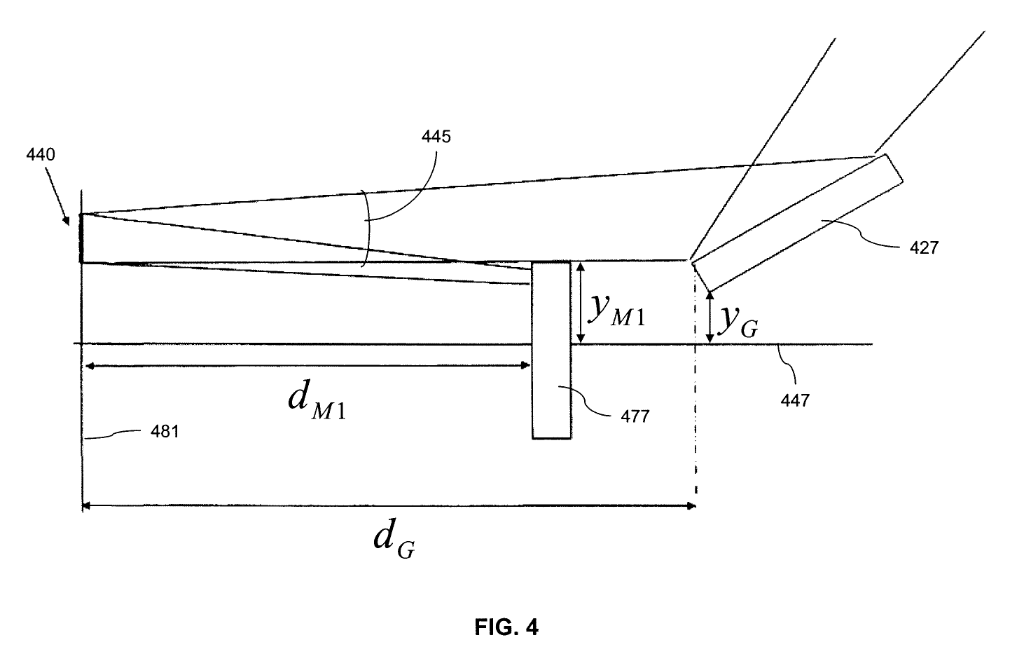

While in the foregoing embodiment, mirror 327 was positioned closer to object plane 381 than the first mirror 377 in projection objective 371, other configurations are also possible. For example, in some embodiments, the grazing incidence mirror that is the last mirror in the radiation path in the illumination system is positioned further from the object plane than the first mirror in the radiation path in the projection objective. Referring to FIG. 4, which shows an example of such a configuration, grazing incidence mirror 427 is positioned further from object plane 481 than mirror 477, which is the first mirror in a projection objective. As indicated in the figure, the minimum distance between mirror 427 and object plane 481 is indicated by d_{G} and the minimum distance between mirror 477 and object plane 481 is indicated by d_{M1}. Here, d_{G}>d_{M1}. Also shown in FIG. 4 are rays 445, which are directed by mirror 427 to illuminate an object field 440 at object plane 481.

Optical axis 447 of the projection objective is also shown. Mirror 477 extends a distance y_{M1} from optical axis 447 on the same side of optical axis 447 as mirror 427. The minimum distance between the base of mirror 427 and optical axis 447 is y_{G}, where y_{G}<y_{M1}.

In embodiments where the grazing incidence mirror in the illumination system is further from the object plane than the first mirror in the projection objective, the separation, yₘᵢₙ, between rays before and after reflection from the reticle, refers to the minimum separation of the rays at the first mirror in the projection objective, rather than the grazing incidence mirror as defined in FIG. 3B.

Configurations where the grazing incidence mirror in the illumination system is further from the object plane than the first mirror in the projection objective can include numerous benefits. For example, such configurations can satisfy the z′>zₘᵢₙ relationship discussed above, allowing for relatively large field heights (dy) and a relatively low CRAO. Furthermore, because mirror 477 is positioned closer to object plane 481 than mirror 427, there is no possibility that rays 445 will be occluded by mirror 427 after reflecting from the reticle at object plane 481. Accordingly, y_{M1} is not constrained by the physical thickness of the base of mirror 427, allowing for thicker bases to be used for mirror 427. In other words, it is not necessary that y_{G}>y_{M1}. Accordingly, larger, more robust and stable mounts can be used for mirror 427 relative to configurations where thin mirror substrates are used because the base thickness constrains y_{M1}. The reduced size and space constraints on mirror 427 and its mount can also allow for additional heat shielding to be used between mirror 427 the components of the projection objective, which can reduce imaging aberrations due to heating of the projection objective by mirror 427.

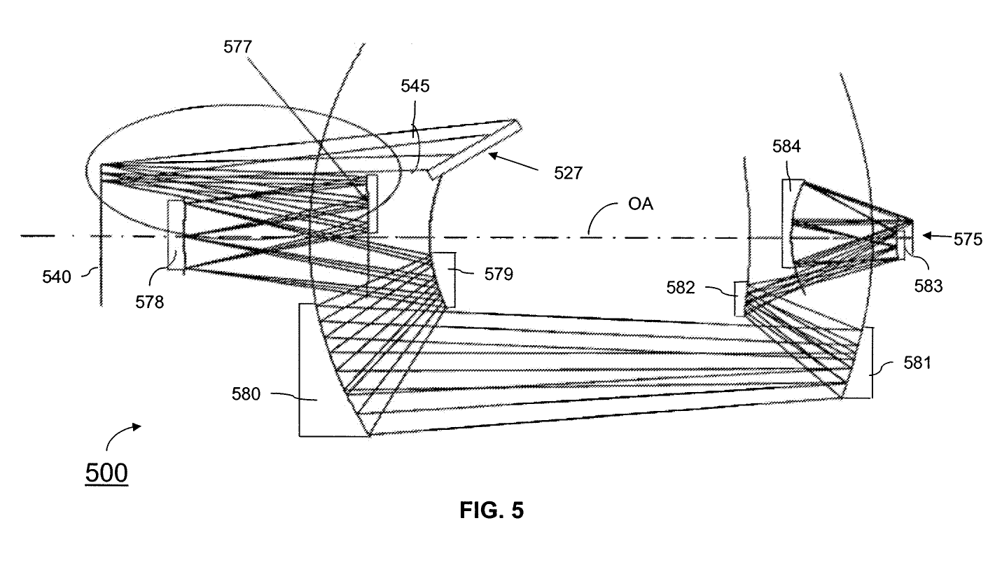

Referring to FIG. 5, an example of a catoptric projection objective 500 and grazing incidence mirror 527 for illuminating a reticle positioned at an object plane 540, is shown, where mirror 527 is positioned further from object plane 500 than a first mirror 577 in the radiation path in projection objective 500. Projection objective 500 images an object field at object plane 540 to an image field at an image plane 575. Projection objective 500 is a catoptric objective and, in addition to mirror 577, includes mirrors 578, 579, 580, 581, 582, 583, and 584, presented in order respect to the path of radiation from object plane 540 to image plane 575. Mirrors 577-584 are positioned along an optical axis, labeled OA. As shown in FIG. 5, each of the mirrors 577-584 corresponds to a segment of a rotationally symmetric surface about OA.

Projection objective 500 has an image side numerical aperture of 0.35, an object side NA of 0.0875, and is a reduction objective with a magnification of 4×. The relative numerical aperture, σ, at object plane 540 of the illumination system is 0.8. The object field has a height, dy, of 40 mm and the CRAO is 6.392°. The distance, y₀, between the central field point and the optical axis is 158 mm.

Grazing incidence mirror 527 is positioned further from object plane 540 than first mirror 577. In particular, the distance between mirror 577 and object plane 540 is 664 mm, while the minimum distance between mirror 527 and object plane 540 is 813 mm. In the meridional plane, the angle, ω, between mirror 527 and the optical axis is 58°.

The minimum separation, yₘᵢₙ, between rays 545, before and after reflection from the reticle measured at mirror 577 is 4.1 mm.

Each mirror 577-584 in projection objective 500 is an aspherical mirror. Aspherical mirror surfaces can be described by the equation:

$$P ( h ) = \frac{δ \cdot h \cdot h}{1 + \sqrt{1 - ( 1 + CC ) \cdot δ \cdot δ \cdot h \cdot h}} + {C}_{1} {h}^{4} + … + {C}_{n} {h}^{2 n + 2} , δ = \frac{1}{R}$$

where P(h) is a distance of the aspherical surface from a plane perpendicular to the optical axis as a function of a perpendicular distance h from the optical axis, and R is a radius of curvature of the mirror at its apex. The parameter CC is the conic constant of the aspheric surface, and parameters C₁ to Cₙ are aspheric constants.

Design data for each mirror in projection objective 500 is shown in Tables I and II. Table I provides R values and distances between mirror surfaces as measured along the optical axis (Referred to as “Thickness”). Table II provides a conic constant and aspheric constants for each mirror.

TABLE I

| Surface | Radius | Thickness | Mode |
|---|---|---|---|
| Object | INFINITY | 664.079 | |
| Mirror 1 | −2248.408 | −457.265 | REFL |
| STOP | INFINITY | 0.000 | |
| Mirror 2 | 1720.732 | 607.265 | REFL |
| Mirror 3 | 410.127 | −296.765 | REFL |
| Mirror 4 | 915.188 | 1385.693 | REFL |
| Mirror 5 | −1017.861 | −297.964 | REFL |
| Mirror 6 | −918.296 | 354.963 | REFL |
| Mirror 7 | 374.571 | −254.963 | REFL |
| Mirror 8 | 329.021 | 294.957 | REFL |
| Image | INFINITY | 0.000 | |

TABLE II

| Surface | CC | C₁ | C₂ | C₃ |
|---|---|---|---|---|
| Mirror 1 | 0.000000E+00 | 9.827635E−10 | −6.947687E−15 | 7.014244E−20 |
| Mirror 2 | 0.000000E+00 | −8.617847E−11 | −2.559048E−15 | 2.420769E−21 |
| Mirror 3 | 0.000000E+00 | −8.656531E−10 | 5.405318E−15 | 4.204975E−20 |
| Mirror 4 | 0.000000E+00 | −5.941284E−11 | −1.211262E−18 | 3.529081E−23 |
| Mirror 5 | 0.000000E+00 | 2.650008E−10 | 3.827055E−16 | −7.598667E−22 |
| Mirror 6 | 0.000000E+00 | 5.266996E−09 | −4.453655E−14 | 3.218187E−19 |
| Mirror 7 | 0.000000E+00 | 8.429248E−09 | 8.347048E−13 | 1.580837E−17 |
| Mirror 8 | 0.000000E+00 | 2.468501E−10 | 3.310980E−15 | 3.228099E−20 |
| Surface | C₄ | C₅ | C₆ | C₇ |
| Mirror 1 | −4.375930E−25 | −3.576925E−30 | 8.030189E−35 | 0.000000E+00 |
| Mirror 2 | −3.480416E−24 | 4.082890E−28 | −2.197698E−32 | 0.000000E+00 |
| Mirror 3 | −1.935657E−24 | 2.726140E−29 | −1.533818E−34 | 0.000000E+00 |
| Mirror 4 | −3.324389E−28 | 5.301103E−34 | −4.669457E−40 | 0.000000E+00 |
| Mirror 5 | 1.018524E−26 | −3.492727E−32 | 6.035810E−38 | 0.000000E+00 |
| Mirror 6 | 2.835576E−24 | −1.042146E−28 | 8.093551E−34 | 0.000000E+00 |
| Mirror 7 | −7.363060E−21 | 1.659178E−24 | −1.489458E−28 | 0.000000E+00 |
| Mirror 8 | 3.862187E−25 | −2.851222E−31 | 1.052318E−34 | 0.000000E+00 |

While the embodiments described above relate to catoptric optical systems, in general, the principles disclosed herein can be applied to catadioptric systems as well. For example, in some embodiments, the illumination system can be a catadioptric illumination system. In certain embodiments, catoptric or catadioptric illumination systems can be used in conjunction with catadioptric or dioptric projection objectives.

As an example, a catoptric illumination system can be used to deliver radiation from a broadband light source, such as a mercury i-line source, to, for example, a dioptric projection objective. The dioptric projection objective can be designed to provide chromatic aberration reduced to a level acceptable for the application for which the system is designed (e.g., for chip packaging applications).

What is claimed is:

1. A system, comprising:
a catoptric projection objective having an optical axis and comprising a plurality of projection objective elements positioned between an object plane and an image plane, the object and image planes being orthogonal to the optical axis and the projection objective being configured so that during operation the projection objective directs radiation reflected at the object plane to the image plane to form an image at the image plane of an object positioned in a field at the object plane, the field having a first dimension of 8 mm or more in a direction orthogonal to the optical axis and a second dimension of 8 mm or more in a direction orthogonal to the optical axis, the first and second dimensions being in orthogonal directions; and
an illumination system comprising a plurality of illumination system elements, the illumination system being configured so that during operation the illumination system directs the radiation to the field at the object plane,
wherein a chief ray of the radiation has an angle of incidence of 10° or less at the object plane.

2. The system of claim 1, wherein the chief ray is the chief ray that intersects the object plane at a central field point.

3. The system of claim 1, wherein the projection objective includes a first projection objective element and the illumination system includes a first illumination system element, the first projection objective element being the first element in a path of the radiation from the object plane to the image plane and the first illumination system element being the last element in the illumination system in the path of the radiation prior to the object plane, the first projection objective element is closer to the object plane than the first illumination system element.

4. The system of claim 1, wherein the illumination system includes a first illumination system element which is the last element in the illumination system in the path of the radiation prior to the object plane, the first illumination system element being positioned a distance zₘᵢₙ or more from the object plane, where zₘᵢₙ is given by the equation:
$${z}_{min} = \frac{dy + {y}_{min}}{Γ} ,$$
in which
$$Γ = tan [ arcsin [ sin ( arctan ( \frac{( {y}_{0} - dy / 2 ) \cdot tan ( CRAO )}{{y}_{0}} ) ) - σ \cdot NAO ) ] ] + tan [ arcsin [ sin ( arctan ( \frac{( {y}_{0} + du / 2 ) \cdot tan ( CRAO )}{{y}_{0}} ) ) - NAO ) ] ] ,$$
where NAO is the numerical aperture of the projection objective at the object plane,
σ is the relative numerical aperture of the illumination system at the object plane,
CRAO is the chief ray angle of a central field point at the object plane,
dy is the dimension of the field in the direction orthogonal to the optical axis,
y₀ is a distance between the central field point and the optical axis, and
yₘᵢₙ is a minimum separation between the radiation and either the first illumination system element or the first projection system element.

5. The system of claim 3, wherein the first illumination system element is positioned further from the optical axis than the field at the object plane.

6. The system of claim 1, wherein the field at the object plane is rectangular-shaped.

7. The system of claim 1, wherein the field at the object plane is arc-shaped.

8. The system of claim 1, wherein the first illumination system element is a mirror.

9. The system of claim 8, wherein the mirror is a plane mirror or a curved mirror.

10. The system of claim 8, wherein the mirror is arranged as a grazing incidence mirror.

11. The system of claim 1, wherein the illumination system comprises a field mirror comprising a plurality of facet mirrors and during operation the illumination system images each facet mirror to the object plane.

12. The system of claim 11, wherein the facet mirrors are rectangular mirrors or arc-shaped mirrors

13. The system of claim 1, wherein the chief ray at a central field point has an angle of incidence of 10° or less.

14. The system of claim 1, wherein the projection objective has an image-side numerical aperture of more than 0.15.

15. The system of claim 1, wherein the projection objective has an image-side numerical aperture of 0.25 or more.

16. The system of claim 1, wherein the projection objective has an object side numerical aperture of about 0.06 or more.

17. The system of claim 1, wherein the projection objective is a reduction projection objective.

18. The system of claim 1, wherein the projection objective is a transfer projection objective.

19. The system of claim 1, wherein the projection objective includes an even number of curved mirrors.

20. The system of claim 1, wherein the object is a reticle.

21. The system of claim 1, wherein the object is configured to reflect radiation from the illumination system.

22. The system of claim 1, further comprising a source configured to produce radiation that is directed by the illumination system to the object plane.

23. The system of claim 22, wherein the radiation has a wavelength that is less than 400 nm.

24. The system of claim 22, wherein the radiation has a wavelength that is about 248 nm or less.

25. The system of claim 22, wherein the radiation has a wavelength that is about 193 nm or less.

26. The system of claim 22, wherein the radiation has a wavelength that is about 13 nm or less.

27. The system of claim 1, wherein the system is a microlithography exposure system.

28. The system of claim 27, wherein the microlithography exposure system is a scanning microlithography exposure system.

29. The system of claim 28, wherein the first direction is the scan direction of the scanning microlithography exposure system.

30. A system, comprising:
a catoptric projection objective having an optical axis and comprising a plurality of projection objective elements including a first projection objective element, the projection objective being configured so that during operation the projection objective directs radiation from an object plane to an image plane to form an image at the image plane of an object positioned in a field at the object plane, the first projection objective element being the first element in a path of the radiation from the object plane to the image plane and the field having a dimension of 8 mm or more in a direction orthogonal to the optical axis; and
an illumination system comprising a plurality of illumination system elements including a first illumination system element, the illumination system being configured so that during operation the illumination system directs the radiation to the field at the object plane, the first illumination system element being the last illumination system element in the path of the radiation prior to the object plane,
wherein a chief ray of the radiation has an angle of incidence of 10° or less at the object plane, and the first illumination system element is on the same side of the object plane as the first projection objective element.

31. A system, comprising:
a projection objective comprising a plurality of projection objective elements including a first projection objective element, the projection objective being configured so that during operation the projection objective directs radiation from an object plane to an image plane to form an image at the image plane of an object positioned at the object plane, the first projection objective element being the first element in a path of the radiation from the object plane to the image plane; and
an illumination system comprising a plurality of elements including a grazing incidence mirror, the illumination system being configured so that during operation the illumination system directs radiation to the field at the object plane, the grazing incidence mirror being the last element in the illumination system in the path of the radiation prior to the object plane,
wherein the first projection objective element is closer to the object plane than the grazing incidence mirror.

32. A system, comprising:
a catoptric projection objective having an optical axis and comprising a plurality of projection objective elements positioned between an object plane and an image plane, the object and image planes being orthogonal to the optical axis and the projection objective being configured so that during operation the projection objective directs radiation reflected at the object plane to the image plane to form an image at the image plane of an object positioned in a field at the object plane, the field having a dimension of 8 mm or more in a direction orthogonal to the optical axis; and
an illumination system comprising a plurality of illumination system elements, the illumination system being configured so that during operation the illumination system directs the radiation to the field at the object plane,
wherein a chief ray of the radiation has an angle of incidence of 10° or less at the object plane, the system is a scanning microlithography exposure system and the direction orthogonal to the optical axis is a scan direction of the scanning microlithography exposure system.
